(19) United States
(12) Patent Application Publication
(10) Pub. No.: US 2021/0404949 A1
(43) Pub. Date: Dec. 30, 2021

(54) MULTI-CAVITY SUPERIMPOSED NON-RESONANT PHOTOACOUSTIC CELL AND GAS DETECTION SYSTEM

(71) Applicant: DALIAN UNIVERSITY OF TECHNOLOGY, Dalian, Liaoning (CN)

(72) Inventors: Zhenfeng GONG, Dalian, Liaoning (CN); Qingxu YU, Dalian, Liaoning (CN)

(21) Appl. No.: 17/289,658

(22) PCT Filed: Jan. 30, 2019
(86) PCT No.: PCT/CN2019/073828

§ 371 Date: Apr. 28, 2021

(30) Foreign Application Priority Data
Jan. 7, 2019 (CN) 201910011769.6

(51) Int. Cl. G01N 21/17

(52) U.S. Cl. CPC G01N 21/1702; G01N 2021/1704

(57) ABSTRACT

The present invention belongs to the field of trace gas detection technology and provides a multi-cavity superimposed non-resonant photoacoustic cell and gas detection system. The multi-cavity superimposed non-resonant photoacoustic cell includes a cylindrical metal shell, a plurality of non-resonant photoacoustic cavities, a sensitive diaphragm of the fiber-optic Fabry-Perot acoustic sensor, an optical glass window, an air inlet and an air outlet. The circular sensitive diaphragm of the fiber-optic Fabry-Perot acoustic sensor is fixed on one side of the cylindrical metal shell, and the other side of the cylindrical metal shell is sealed by an optical glass window. The gas to be measured enters through the inlet, diffuses into a plurality of non-resonant photoacoustic cavities, and exits through the outlet on the other side.

### TECHNICAL FIELD

The present invention belongs to the field of trace gas detection technology and relates to a multi-cavity superimposed non-resonant photoacoustic cell structure and a highly sensitive gas detection system based on the photoacoustic cell.

### BACKGROUND

Trace gas detection is gaining more and more attention in the fields of industrial process control, environmental monitoring, health detection and hazardous material detection. With the development of laser technology, spectroscopy technology has become a gas detection method with the advantages of high sensitivity, fast response and high selectivity. Photoacoustic spectroscopy is a spectroscopic calorimetric technique by directly measuring the heat released by the gas due to the absorption of light energy, and it is a background-free absorption spectroscopy technique. The basic principle of gas photoacoustic spectroscopy technique is that after the gas to be measured absorbs light energy in a special wavelength band, the gas molecules jump from the ground state to the excited state, but due to the instability of the excited state at high energy levels, they will revert to the ground state through collisional relaxation, and at the same time, according to the law of energy conservation, the absorbed light energy is converted into the advective energy of the molecules, which causes the local temperature in the gas cell to rise. When the excitation light is periodically modulated, the local temperature in the gas cell will periodically increase and decrease, thus generating an acoustic wave signal consistent with the laser modulation frequency. The acoustic signal is collected by an acoustic detector and the concentration information of the gas to be measured is obtained through analysis and processing.

In a detection system based on photoacoustic spectroscopy, the photoacoustic cell is the place where the acoustic waves are generated. The photoacoustic cell is divided into two structures: resonant photoacoustic cell and non-resonant photoacoustic cell. The non-resonant photoacoustic cell is smaller and can be used in conjunction with an infrared light source. Due to the broad-spectrum characteristics of infrared light sources, non-resonant photoacoustic systems can measure a wider variety of gases, so for existing online photoacoustic spectrometers, including GE's Kelman TRANSFIX series and CAMLIN POWER's TOTUS series, non-resonant photoacoustic cells are commonly used as acoustic wave generation units. For the non-resonant photoacoustic cell system, the photoacoustic signal can be improved by reducing the cross-sectional area of the photoacoustic cell cavity, but a too small cavity cross-section makes it difficult to match with the microphone; in addition, the photoacoustic signal can be improved by reducing the modulation frequency of the excitation light source, but the response capability of the small-sized microphone for low-frequency acoustic signals is relatively weak. Combined with the above reasons, the sensitivity of the traditional non-resonant photoacoustic system is low. Therefore, the design of a high-sensitivity non-resonant photoacoustic cell system is of great value for applications in the field of trace gas detection.

### SUMMARY

The purpose of the present invention is to propose a multi-cavity superimposed non-resonant photoacoustic cell and gas detection system, which aims to solve the problem of low sensitivity of the conventional non-resonant photoacoustic system. The use of fiber optic acoustic sensor as acoustic detection unit can solve the problem of mismatch between microphone and photoacoustic cell and electromagnetic interference in complex environment, expanding a larger space for online application of photoacoustic spectroscopy technology.

### Technical Solution of the Present Invention

A multi-cavity superimposed non-resonant photoacoustic cell, including a cylindrical metal shell 1, multiple non-resonant photoacoustic cavities 2, sensitive diaphragm of the fiber-optic Fabry-Perot acoustic sensor 3, optical glass window 4, air inlet 5 and air outlet 6; both ends of the cylindrical metal shell 1 are open, and interior of the cylindrical metal shell 1 contains multiple interconnected cylindrical through-holes, polished as the non-resonant photoacoustic cavities 2; one end of the cylindrical metal shell 1 is fixed with the sensitive diaphragm of the fiber-optic Fabry-Perot acoustic sensor 3 by laser welding metal film or gluing organic film, and the other end is sealed by the optical glass window 4; one end of the cylindrical metal shell 1 has the air inlet 5 and the other end has the air outlet 6, and the gas to be measured enters through the air inlet 5, diffuses into the multiple non-resonant photoacoustic cavities 2, and then discharges through the air outlet 6 at the other end.

For the multi-cavity superimposed non-resonant photoacoustic cell, the photoacoustic signal amplitude is inversely proportional to the size of the cross-section of a single non-resonant photoacoustic cavity 2 and the size of the modulation frequency of the excitation light source, respectively. The cross-sectional area of the non-resonant photoacoustic cavity 2 is small, so a strong photoacoustic signal is generated inside the individual non-resonant photoacoustic cavity 2. At the same time, the photoacoustic signals generated within each non-resonant photoacoustic cavity 2 are superimposed at the sensitive diaphragm of the fiber-optic Fabry-Perot acoustic sensor 3, further enhancing the photoacoustic signals of the multi-cavity superimposed non-resonant photoacoustic cell. The superimposed photoacoustic signals cause periodic vibration of the sensitive diaphragm of the fiber-optic Fabry-Perot acoustic sensor 3, and the gas concentration measurement is achieved by demodulating the vibration condition of the sensitive diaphragm of the fiber-optic Fabry-Perot acoustic sensor 3.

A gas detection system based on a multi-cavity superimposed non-resonant photoacoustic cell, including an infrared thermal radiation light source 7, a chopper 8, a filter 9, a multi-cavity superimposed non-resonant photoacoustic cell 10, an fiber-optic Fabry-Perot acoustic sensor 11, a tunable semiconductor laser 12, a circulator 13, a photodetector 14, a data acquisition card 15 and an industrial control computer 16; the broad-spectrum light emitted from the infrared thermal radiation light source 7 is modulated by the modulation of the chopper 8 and the band-pass effect of the filter 9, the broad-spectrum light becomes narrow-band light applicable to a single gas absorption; if measuring multi-component gases, multiple filters 9 are configured; the narrow-band light is incident into the multi-cavity superimposed non-resonant photoacoustic cell 10 through the optical glass window 4, due to the photoacoustic effect, the photoacoustic signals are generated in the non-resonant photoacoustic cavity 2, and the sound pressures are basically equal everywhere in the non-resonant photoacoustic cavities 2; an fiber-optic Fabry-Perot acoustic sensor 11 is used as the acoustic detection unit, which solves the problem that the traditional microphone can not match with the photoacoustic cell with a small cross-sectional area, and the photoacoustic signals can be further improved by reducing the modulation frequency of the excitation light source, leading to a decrease of the gas detection limit sensitivity of the system.

The beneficial effect of the invention: By reducing the radius of the non-resonant photoacoustic cavity and the superposition of photoacoustic signals of multiple photoacoustic cavities, the intensity of photoacoustic signals of the system can be substantially improved. The diaphragm-based fiber-optic Fabry-Perot acoustic sensor as an acoustic detection unit is easier to match with the photoacoustic cavity, providing a new solution for multi-component high-sensitivity trace gas detection.

### DESCRIPTION OF THE DRAWINGS

FIG. 1 is a schematic diagram of the structure of a multi-cavity superimposed non-resonant photoacoustic cell.

FIG. 2 is a schematic diagram of a gas detection system based on a multi-cavity superimposed non-resonant photoacoustic cell.

In the figure: 1 cylindrical metal shell; 2 non-resonant photoacoustic cavity; 3 sensitive diaphragm of the fiber-optic Fabry-Perot acoustic sensor; 4 optical glass window; 5 air inlet; 6 air outlet; 7 infrared thermal radiation light source; 8 chopper; 9 filter; 10 multi-cavity superimposed non-resonant photoacoustic cell; 11 fiber-optic Fabry-Perot acoustic sensor; 12 tunable semiconductor laser; 13 circulator; 14 photodetector; 15 data acquisition card; and 16 industrial control computer.

### DETAILED DESCRIPTION

The specific embodiments of the present invention are further described below in conjunction with the accompanying drawings and technical solutions.

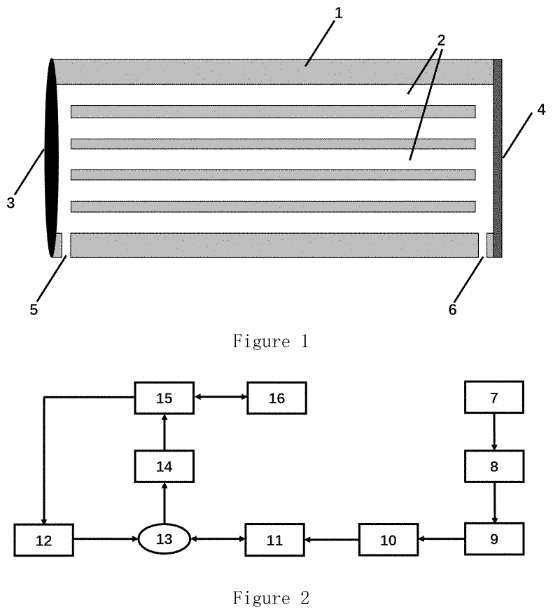

The present invention provides a multi-cavity superimposed non-resonant photoacoustic cell as shown in FIG. 1, mainly consisting of a cylindrical metal sheet 1, several non-resonant photoacoustic cavities 2, a sensitive diaphragm of the fiber-optic Fabry-Perot acoustic sensor 3, an optical glass window 4, an air inlet 5 and an air outlet 6. The sensitive diaphragm of the fiber-optic Fabry-Perot acoustic sensor 3 is fixed at one end of the multi-cavity superimposed non-resonant photoacoustic cell, and the photoacoustic signals generated in the multiple non-resonant photoacoustic cavities 2 are superimposed at the position of the sensitive diaphragm of the fiber-optic Fabry-Perot acoustic sensor 3, causing the periodic vibration of the sensitive diaphragm of the fiber-optic Fabry-Perot acoustic sensor 3. The concentration information of the gas to be measured can be obtained by demodulating and analyzing the vibration of the sensitive diaphragm of the fiber-optic Fabry-Perot acoustic sensor 3. At the other end of the multi-cavity superimposed non-resonant photoacoustic cell, there is an optical glass window 4, which allows the excitation light to pass smoothly, and the side walls near the two ends of the multi-cavity superimposed non-resonant photoacoustic cell are equipped with air inlet 5 and air outlet 6, respectively.

FIG. 2 represents a gas detection system based on the multi-cavity superimposed non-resonant photoacoustic cell. The broad-spectrum light emitted from the infrared thermal radiation light source 7 becomes periodically modulated light after passing through the chopper 8, and the periodically modulated light becomes narrow-band light that can be absorbed by the gas to be measured after passing through the band-pass filter 9. The modulated narrow-band light passes through the optical glass window 4 into the multiple non-resonant photoacoustic cavities 2 of the multi-cavity superimposed non-resonant photoacoustic cell 10. The gas to be measured absorbs the periodically modulated narrow-band light in the non-resonant photoacoustic cavity 2 to generate a photoacoustic signal, and the photoacoustic signals in the multiple non-resonant photoacoustic cavities 2 are superimposed at the position of the sensitive diaphragm of the fiber-optic Fabry-Perot acoustic sensor 3, causing periodic vibration of sensitive diaphragm of the fiber-optic Fabry-Perot acoustic sensor 3. As the detection light source of the fiber-optic Fabry-Perot acoustic sensor 11, the laser from the tunable semiconductor laser 12 is incident into the Fabry-Perot cavity of the fiber-optic Fabry-Perot acoustic sensor 11 through the circulator 13, and the reflected light from the fiber end face and the reflected light from the sensitive diaphragm of the fiber-optic Fabry-Perot acoustic sensor 3 interferes. The periodic vibration of the sensitive diaphragm of the fiber optic Fabry-Perot acoustic sensor 3 causes a periodic change in the length of the Fabry-Perot cavity, which causes a periodic change in the interferometric light signal. The reflected interference light is received by the photodetector 14 through the circulator 13, which converts the interference light signal into an electrical signal, and the amplified electrical signal is collected by the data acquisition card 15, and finally the signal is sent to the industrial control computer 16 for processing. The data acquisition card 15 controls the tunable semiconductor laser 12 through the driver, and uses the wavelength tuning function of the tunable semiconductor laser 12 to compensate for the drift of the working point and achieve the stability of the working point.

The above description is only a preferred embodiment of the present invention and is not intended to limit the present invention, which is subject to various changes and variations for a person skilled in the art. Any modification, equivalent replacement, improvement, etc. made within the spirit and principles of the present invention shall be included in the scope of protection of the present invention.

1. A multi-cavity superimposed non-resonant photoacoustic cell, wherein the multi-cavity superimposed non-resonant photoacoustic cell comprises a cylindrical metal shell, a plurality of non-resonant photoacoustic cavities, a sensitive diaphragm of the fiber-optic Fabry-Perot acoustic sensor, an optical glass window, an air inlet and an air outlet; the cylindrical metal shell has an open structure at both ends, interior of the cylindrical metal shell contains multiple interconnected cylindrical through-holes, polished as the non-resonant photoacoustic cavities; one end of the cylindrical metal shell is fixed by laser welding or gluing the sensitive diaphragm of the fiber-optic Fabry-Perot acoustic sensor, and the other end is sealed by the optical glass window; one end of the cylindrical metal shell has the air inlet and the other end has the air outlet, and the gas to be measured enters through the air inlet, diffuses into the multiple non-resonant photoacoustic cavities, and then discharges through the air outlet at the other end.

2. A gas detection system based on the multi-cavity superimposed non-resonant photoacoustic cell of claim 1, wherein the gas detection system includes an infrared thermal radiation light source, a chopper, a filter, a multi-cavity superimposed non-resonant photoacoustic cell, a fiber-optic Fabry-Perot acoustic sensor, a tunable semiconductor laser, a circulator, a photodetector, a data acquisition card, and an industrial control computer; the broad-spectrum light emitted from the infrared thermal radiation light source becomes narrow-band light applicable to the absorption of a single gas after the modulation of the chopper and the band-pass effect of the filter; for multi-component gas measurements, multiple filters are configured; the narrow-band light is incident through the optical glass window into the multi-cavity superimposed non-resonant photoacoustic cell; due to the photoacoustic effect, the photoacoustic signal is generated in the non-resonant photoacoustic cavity, and the sound pressure at each place in the non-resonant photoacoustic cavity is equal; the fiber-optic Fabry-Perot acoustic sensor is used as the acoustic wave detection unit.
